(19) United States
(12) Patent Application Publication
(10) Pub. No.: US 2023/0154331 A1
(43) Pub. Date: May 18, 2023

(54) METHOD AND DEVICE FOR ASSISTING AUTONOMOUS VEHICLES TO DRIVE IN A ROAD JUNCTION

(71) Applicant: Volvo Autonomous Solutions AB, Gõteborg (SE)

(72) Inventors: Linus HAGVALL, Gõteborg (SE); Stefan BERGQUIST, Gõteborg (SE); Christan GRANTE, Västra Frölunda (SE)

(73) Assignee: Volvo Autonomous Solutions AB, Gõteborg (SE)

(21) Appl. No.: 18/052,749

(22) Filed: Nov. 4, 2022

(30) Foreign Application Priority Data
Nov. 12, 2021 (EP) 21208062.6

(51) Int. Cl. G08G 1/16; G08G 1/0967; G08G 1/01

(52) U.S. Cl. CPC G08G 1/164; G08G 1/0116; G08G 1/0141; G08G 1/0145; G08G 1/166; G08G 1/096725

(57) ABSTRACT

A computer-implemented method for assisting one or more autonomous vehicles to drive in a road junction. The road junction comprises a plurality of traffic zones, including a central zone arranged for use by the one or more autonomous vehicles and one or more secondary vehicles and at least one edge zone for use by the one or more secondary vehicles for entering the central zone. The method comprises obtaining sensor data from a set of sensors arranged in the road junction for monitoring the plurality of traffic zones. The sensor data is indicative of objects present in the plurality of traffic zones. Based on the obtained sensor data, it is determined whether there are any objects present in the plurality of traffic zones. In response to determining that at least one object is present in the at least one edge zone indicating to the one or more autonomous vehicles that the road junction is occupied.

### TECHNICAL FIELD

The invention relates to a computer-implemented method and a control unit. The invention further relates to a sensing arrangement, a computer program, and a computer readable medium. In particular, embodiments herein relate to assisting autonomous vehicles to drive in a road junction.

The invention is applicable within fields of traffic management, in particular where there is a need to separate traffic of autonomous vehicles with traffic of other secondary vehicles.

### BACKGROUND

In isolation from other traffic, a group of autonomous vehicles are typically able to well coordinate their road usage in a safe manner and in an efficient flow of traffic. However, when autonomous vehicles are to share their road space with vehicles which they cannot easily coordinate with, such as manually driven vehicles or non-compatible autonomous vehicles, challenges arise in how to maintain traffic safety and how to keep an efficient traffic flow. For example, when autonomous vehicles and manually driven vehicles, such as cars, bicyclists, etc. need to share an intersection, it is typically dangerous for the autonomous vehicles and the manually driven vehicles to drive in the road junction concurrently as it is associated with a high risk for collision, e.g. as the autonomous vehicle may not be able to react quickly enough and/or the behaviour of the manually driven vehicles cannot be predicted well enough by the autonomous vehicles. To overcome this issue, the manually driven vehicles are typically separated from the autonomous vehicles in time by the use of traffic lights. The traffic lights dictate a distinct time period for which of the manual vehicles or the autonomous vehicles are granted to drive in the road junction at which time period. However, when the autonomous vehicles are granted to drive in the road junction, i.e. when the traffic light turns green for the autonomous vehicles, there may still be manually driven vehicles in the road junction which thus cause a safety concern. The manually driven vehicles may be in the road junction for a wide number of reasons e.g. the manually driven vehicles may not have had time to exit the road junction yet, the manually driven vehicles may have stopped due to malfunction, or the manually driven vehicles may have driven in the road even though they were not allowed, i.e. they entered the road junction even though the traffic lights displayed a red light for the manually driven vehicles. While these examples discuss autonomous vehicles and manually driven vehicles sharing a road junction, similar problems also occur when different types of autonomous vehicles are sharing a road junction, i.e. wherein the different types of autonomous vehicles are unable to coordinate the use of the road junction, e.g. as they communicate using different non-compatible protocols or communication technologies.

To overcome these problems, it is possible to separate autonomous traffic such that the autonomous vehicles are only using roads and road junctions shared only by autonomous vehicles which are able to coordinate traffic and road junction use with high precision. Since this demands duplicated road infrastructure it is however not often feasible as cities and road areas simply lack the space needed for this solution. Furthermore, even if the road junctions for autonomous vehicles are completely isolated, it is not always possible to completely ensure that no human actor enters these road junctions.

Another solution is to switch to a manual control when autonomous vehicles are traversing a shared road junction. This however demands that an operator is present in the car or present for remote control which is not always the case and may thus halt traffic while waiting for the operator.

Another solution is to try to rely on sensors on the autonomous vehicles to detect object and obstacles in the road junction, such as manually driven vehicles, and when they are detected, resolve the solution by performing an emergency stop and alerting other autonomous vehicles that the road junction is occupied. However, when manually driven vehicles linger in the road junction, e.g. due to a lot of traffic and slowly driven vehicles, this solution exaggerates an amount of emergency stops necessary which may need a lot of time to be resolved, e.g. since an operator may need to manually restart the autonomous vehicles when they have performed an emergency stop. Furthermore, to detect whether persons may be lying down or to detect small obstacles in the road junction, the sensors mounted at the autonomous vehicles need to be mounted at very low positions of the respective autonomous vehicle. The sensors will in these scenarios be very sensitive to bumps or other inclinations which thus may disturb the sensors and may severely limit how the autonomous vehicles can operate. Furthermore, the sensors mounted to the autonomous vehicles may be very close to obstacles when detecting them, and thus, when the autonomous vehicle is notified of obstacles in the road junction, it may be too late to prevent a collision.

Hence, there is a need for improved safety and efficiency for road junction traffic management of autonomous vehicles.

### SUMMARY

An object of the invention is to improve the safety and efficiency of autonomous vehicles driving in road junctions shared with other vehicles. According to a first aspect of the invention, the object is achieved by a computer-implemented method according to claim 1.

According to the first aspect, there is provided a computer-implemented method for assisting one or more autonomous vehicles to drive in a road junction. The road junction comprises a plurality of traffic zones. The plurality of traffic zones comprise a central zone arranged for use by the one or more autonomous vehicles and one or more secondary vehicles. The plurality of traffic zones comprise at least one edge zone for use by the one or more secondary vehicles for entering the central zone. The computer-implemented method comprises:
Obtaining sensor data from a set of sensors arranged in the road junction for monitoring the plurality of traffic zones. The sensor data is indicative of objects present in the plurality of traffic zones.
Based on the obtained sensor data, determining whether there are any objects present in the plurality of traffic zone.
In response to determining that at least one object is present in the at least one edge zone, indicating to the one or more autonomous vehicles that the road junction is occupied.

Objects in any of the plurality of traffic zones as used in embodiments herein may be any actor or obstacle, such as human actors, animals or other road users, such as any secondary vehicle. In these situations, when determining that at least one object is present in the at least one edge zone, it is interpreted that one of the secondary vehicles may soon enter the central zone via the at least one edge zone. This may risk that the autonomous vehicles and the secondary vehicles would drive in the central zone concurrently, which would risk a collision or other accident. Thus, to avoid a potential accident, it is indicated to the one or more autonomous vehicles that the road junction is occupied, i.e. occupied by the secondary vehicles. In this way, the one or more autonomous vehicles is informed that the central zone has incoming traffic in the form of the secondary vehicles. Since it is indicated that the road junction is occupied when the secondary vehicles are in the at least one edge zone, i.e. before reaching the central zone, the one or more autonomous vehicles have a sufficient amount of time to react. For example, the one or more autonomous vehicles may determine if and/or which suitable preventive action is needed. An emergency stop may be a suitable action, e.g. in particular when the one or more autonomous vehicles are present in, or are approaching the central zone. In other scenarios, when the one or more autonomous vehicles have already had time to exit the central zone, it may not be necessary to perform any preventive action.

Optionally, the computer-implemented method may further comprise:

-In response to determining that no objects are present in the plurality of traffic zones, signalling to the one or more autonomous vehicles that it is safe to enter the central zone. This signalling may be performed prior to indicating to the one or more autonomous vehicles that the road junction is occupied. When determining that there are no objects present in the plurality of zones, it is implied that no objects are present in the central zone, nor in the at least one edge zone. In other words, it is deduced that no objects are in the central zone, nor is any secondary vehicle about to enter the central zone via the at least one edge zone. Hence, it is safe for the autonomous vehicles to enter the central zone. In other words, in these embodiments, the autonomous vehicles will only enter the central zone when it is not occupied and when it is known that no secondary vehicles are entering or about to enter the non-occupied central zone. In this way, an improved safety and efficiency of managing traffic in the road junction is achieved. Furthermore, when the one or more autonomous vehicles have been signalled that it is safe to enter the central zone, it may be implied that the autonomous vehicles are approaching or driving in the central zone.

Optionally, the computer-implemented method may further comprise:
In response to determining that no objects are present in the plurality of traffic zones, adapting the set of sensors not to monitor the central zone. For example, adapting the set of sensors not to monitor the central zone may comprise any or more out of:
   adjusting an active Field of View (FOV) of at least one sensor out of the set of sensors, or
   deactivating at least one sensor out of the set of sensors.

In other words, in these embodiments, any sensor out of the set of sensors may be adjusted to monitor some other zone or may be deactivated until needed again. Since it is known that no objects are present in the plurality of traffic zones, and it is also known that the at least one edge zone is to be used by the secondary vehicles for entering the central zone, monitoring the central zone may not be useful and hence the sensors may be deactivated or adapted to a more useful purpose which thus improves the efficiency of traffic management.

Optionally, the computer-implemented method may further comprise:

- Obtaining a traffic signal from a traffic coordinating unit. The traffic signal indicates whether the one or more autonomous vehicles, or the one or more secondary vehicles, are granted to enter the central zone.

In these embodiments, signalling to the one or more autonomous vehicles that it is safe to enter the central zone may further be performed in response to the obtained traffic signal indicating that the one or more autonomous vehicles are granted to enter the central zone. In other words, the autonomous vehicles may be supported by a traffic coordinating unit such as a traffic light to further improve the safety of managing the traffic in the road junction.

Optionally, indicating to the one or more autonomous vehicles that the road junction is occupied fulfils a real-time condition. For example, the autonomous vehicles may be notified before the secondary vehicles enter the central zone.

Optionally, indicating to the one or more autonomous vehicles that the road junction is occupied comprises triggering the one or more autonomous vehicles to perform an emergency stop.

Optionally, signalling to the one or more autonomous vehicles that it is safe to enter the central zone comprises periodically transmitting one or more heartbeat signals to the one or more autonomous vehicles. In these embodiments, indicating to the one or more autonomous vehicles that the road junction is occupied comprises ceasing transmitting the one or more heartbeat signals to the one or more autonomous vehicles. In other words, the one or more autonomous vehicles may be assured that they are using the central zone exclusively as long as they are receiving the heartbeat signal. Alternatively, according to exemplary embodiments herein, indicating to the one or more autonomous vehicles that the road junction is occupied comprises transmitting an alert signal to the one or more autonomous vehicles. In these embodiments, the alert signal indicates that the road junction is occupied.

According to a second aspect, a control unit configured to perform the method according to the first aspect is provided.

According to a third aspect, a sensing arrangement for a road junction is provided. The sensing arrangement comprises the control unit according to the second aspect. The sensing arrangement further comprises a set of sensors arranged in the road junction for monitoring the plurality of traffic zones. The set of sensors are configured to detect objects present in the plurality of traffic zones and configured to communicate sensor data indicative of detected objects to the control unit.

Optionally, the set of sensors comprises one or more sensors with an object detection error rate lower than a predetermined threshold.

Optionally, the set of sensors comprises one or more sensors with a configurable FOV.

Optionally the set of sensors comprises one or more sensors with an object detection rate fulfilling a predetermined real-time condition.

According to a fourth aspect, a computer program comprising program code means for performing the method of the first aspect when said program is run on a computer is provided.

According to a fifth aspect, a computer readable medium carrying a computer program comprising program code means for performing the method of the first aspect when said program product is run on a computer is provided.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic block diagram illustrating embodiments herein.

FIGS. 2a-c are schematic block diagrams illustrating embodiments herein.

FIG. 3 is a flowchart illustrating a method according to embodiments herein.

FIG. 4 is a schematic block diagram illustrating a scenario according to embodiments herein.

FIG. 5 is a schematic block diagram illustrating a scenario according to embodiments herein.

FIG. 6 is a schematic block diagram illustrating a scenario according to embodiments herein, and

FIGS. 7a-b are schematic block diagrams illustrating a control unit according to embodiments herein.

### DETAILED DESCRIPTION OF EXAMPLE EMBODIMENTS OF THE INVENTION

Embodiments herein relate to assisting autonomous vehicles to drive in a road junction. The term autonomous vehicle herein relates to vehicles which are able to navigate and drive on roads and road junctions completely or at least partially without continuous input from a driver or operator.

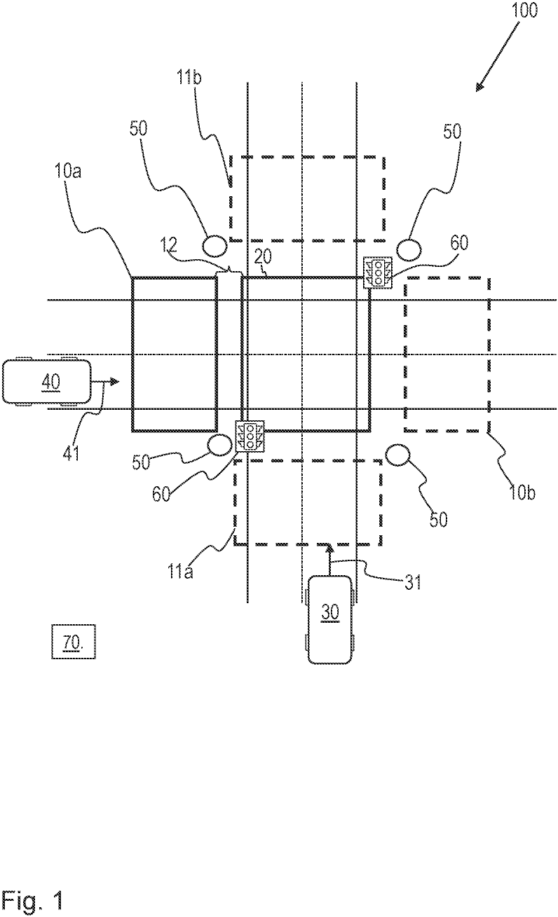

FIG. 1 is a schematic overview of a road junction 100 in accordance with embodiments herein. The road junction 100 is in FIG. 1 illustrated as an intersection, however, embodiments herein are not limited to intersections. In the road junction 100, different vehicles drive and operate such as one or more autonomous vehicles 30. The one or more autonomous vehicles 30 may be autonomous vehicles which, among themselves, are capable of coordinating traffic and driving on roads and in the road junction 100.

In the road junction 100 other vehicles also drive and operate such as one or more secondary vehicles 40. In some embodiments the one or more secondary vehicles 40 may be manually driven vehicles, e.g. cars, trucks, bicycles etc. In some other embodiments the one or more secondary vehicles 40 are autonomous vehicles of another type than the one or more autonomous vehicles 30. In any of these embodiments, the one or more secondary vehicles 40 may be unable to coordinate traffic in the road junction 100 with the one or more autonomous vehicles 30.

In the road junction 100, a set of sensors 50 is arranged. The set of sensors 50 is arranged to monitor and/or to detect a presence of objects in a plurality of traffic zones. The plurality of zones may be parts of the road junction 100 such as roads in or leading up to the road junction. The plurality of traffic zones may also include areas surrounding roads such as sidewalks, etc.

The plurality of traffic zones comprises a central zone 20 and a set of edge zones 10a, 10b, 11a, 11b. The central zone 20 is a shared traffic zone in the road junction wherein both of the one or more autonomous vehicles 30 and the one or more secondary vehicles 40 are arranged to drive. In FIG. 1 this is illustrated in that the central zone is the centre-part of an intersection. The one or more autonomous vehicles 30 are on a path to traverse the central zone 20 in driving direction 31, and the one or more secondary vehicles 40 are on a path to traverse the central zone 20 in a separate driving direction 41 from the one or more autonomous vehicles 30. Driving direction 41 and 31 may be perpendicular as illustrated in FIG. 1.

The set of edge zones 10a, 10b, 11a, 11b comprises one or more traffic zones which are arranged to be traversed to reach the central zone 20. Any edge zone in the set of edge zones 10a, 10b, 11a, 11b, as illustrated in FIG. 1. may slightly overlap the central zone, or be adjacent to the central zone, or may have a distance 12 between the respective edge zone and the central zone. In some of these embodiments, the distance 12 is less than a predetermined distance threshold.

The set of edge zone comprises at least one edge zone 10a, 10b, for use by the one or more secondary vehicles 40 for entering the central zone 20. The at least one edge zone 10a, 10b, may be monitored to detect whether or not there are any objects therein, e.g. which would indicate that the secondary vehicles 40 may soon enter the central zone 20. In FIG. 1, this is illustrated by a first edge zone 10a for entering the central zone 20. However, as traffic may go in both directions, there may be at least two entries in the intersection for the one or more secondary vehicles 40, and hence, a second edge zone 10b may be provided for use by the one or more secondary vehicles 40 for entering the central zone 20. The second edge zone 10b is in FIG. 1 on the opposite side of the central zone from the first edge zone 10a, however, other arrangements of edge zones may also be possible, e.g. if the secondary vehicles 40 are arranged to turn in the intersection illustrated in FIG. 1. In some embodiments, the at least one edge zone 10a, 10b, comprises all traffic zones in which the secondary vehicles 40 are capable of traversing, or intended to traverse, for reaching the central zone 20.

In some scenarios (not shown in FIG. 1), the road junction 100 comprises more than two edge zones for use by the one or more secondary vehicles 40 to enter the central zone 20.

As shown in FIG. 1, the set of edge zones may optionally comprise one or more additional edge zones 11a, 11b, for use by the one or more autonomous vehicles 30 for entering the central zone 20. In some embodiments, when the one or more autonomous vehicles 30 are travelling in the central zone 20, there should not be any traffic in the additional edge zones 11a, 11b. However, to further ensure that no vehicle is travelling in these traffic zones, the additional edge zones 11a, 11b, may be arranged to be monitored by the set of sensors 50. Thereby, it is possible to determine whether or not any vehicle, e.g. the secondary vehicles 40, are traversing the one or more additional edge zones 11a, 11b, which would indicate that the secondary vehicles 40 may soon enter the central zone 20. Furthermore, it may also be possible to detect when the secondary vehicles 40 perform a wrong exit in the road junction 100, which may in some scenarios need to trigger an emergency stop at the one or more autonomous vehicles 30.

The sizes of any of the edge zones 10a, 10b, 11a, 11b may be adapted based on a maximum estimated or allowed travel speed in the respective edge zone, such that the one or more autonomous vehicles 30 have enough time to perform a preventive action such as an emergency break, e.g. before a vehicle crossing the respective edge zone reaches the central zone 20.

As traffic may go both ways, e.g. on two-way roads, any edge zone in the set of edge zones 10 may furthermore be traffic zones for both entering and exiting the central zone 20. Embodiments herein are however not limited to two-way roads. For example, embodiments herein are also applicable wherein any suitable number of the edge zones in the set of edge zones 10a, 10b, 11a, 11b, or central zone 20 are one-way roads or are connected with one-way roads.

The one or more autonomous vehicles 30 may be connected to a control unit 70. The one or more autonomous vehicles 30 may be arranged to receive indications and signals from the control unit 70, e.g. which informs the one or more autonomous vehicles 30 about whether the road junction 100 is safe or occupied. The one or more autonomous vehicle 30 may further be arranged to indicate their position to the control unit 70, e.g. by means of transmitting a signal through a wireless connection. In some of these embodiments, any one or more of the one or more autonomous vehicle 30 may determine their location e.g. by use of Global Positioning System (GPS) sensors, or by use of Light Detection and Ranging (Lidar) sensors using scan matching of the road junction 100. The one or more autonomous vehicles 30 may then, based on their location, indicate their location to the control unit 70. The one or more autonomous vehicles 30 may also indicate to the control unit 70 that they are present in a certain traffic zone, and/or if they have left a certain traffic zone. The control unit 70 may be arranged in the road junction 100 or may be located at a remote location, e.g. in a server or as part of a cloud service. The control unit 70 may be connected to the set of sensors 50, e.g. by means of a wired or wireless connection. The control unit 70 may control the set of sensors 50 to monitor the plurality of traffic zones. The control unit 70 may obtain sensor data indicative of whether or not there are any objects present in a traffic zone, e.g. in the central zone 20 and/or in the at least one edge zone 10a, 10b. Methods herein may in some embodiments, at least partially, be performed by the control unit 70.

In some embodiments, there may be additional security arrangements provided to hinder people, animals or vehicles to drive unsafe which further defines which areas the plurality of zones shall monitor. For example, fences and/or other suitable barriers may be arranged around the plurality of traffic zones to limit access to the plurality of traffic zones to vehicles only. In some embodiments the central zone 20 may be arranged with speed bumps, chicanes, or other speed regulators, e.g. forcing vehicles to drive a slower path, e.g. a zig-zag path, for increased safety. Thus, vehicles would slow down and thus increase a time it would take for them to traverse the central zone 20. An advantage of reducing the speeds of vehicles is that it takes an increased amount of time for the vehicles to enter the central zone 20, i.e. time to traverse an edge zone is reduced. In this way, sizes of areas relating to any of the edge zones may be reduced and fewer sensors may be needed to monitor these edge zones.

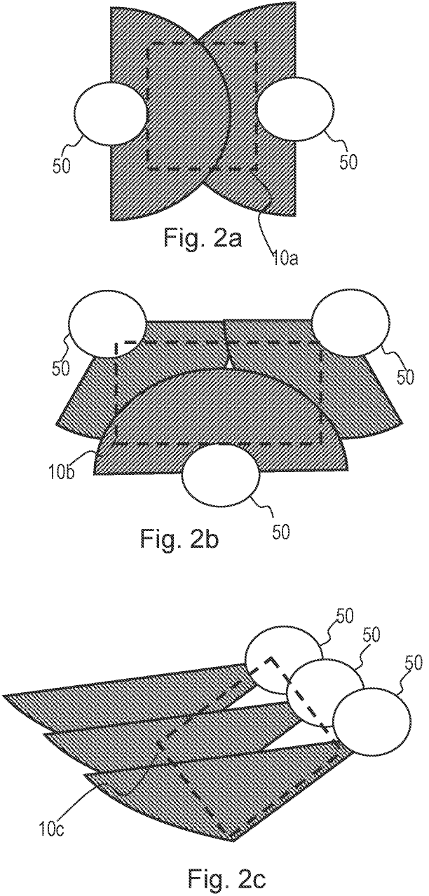

FIGS. 2a-c illustrates the set of sensors 50 in various example configurations and arrangements. The set of sensors 50 may be part of a sensing arrangement for the road junction 100. The sensing arrangement may comprise the control unit 70. Each sensor in the set of sensors 50 may be arranged to monitor different areas, i.e. they have different active FOVs. Each respective sensor may have a configurable FOV, typically up to 180 degrees angles, which determines their monitored area or FOV, however, larger or smaller angles may also be possible. The different monitored areas may at least partially monitor at least part of one of the plurality of traffic zones. While illustrated herein as rectangles, any of the plurality of traffic zones may be any suitable shape based on how the set of sensors are arranged to monitor areas in the road junction 100. The monitored areas in the plurality of traffic zones may need to be in periphery, connected or adjacent to the set of sensors 50. This may be since the sensors may monitor the plurality of traffic zones by sending out straight lines and may wait for a reflection. Each sensor in the set of sensors 50 may be arranged in a respective location in the road junction 100 and may be associated with a respective sensing angle and sensing direction. The set of sensors 50 may typically comprise high integrity sensors which may have a low object detection error rate, e.g. lower than a predetermined threshold. The set of sensors 50 may have an object detection rate fulfilling one or more predetermined real-time conditions. One real-time condition may be that when detecting an object, the set of sensors 50 may need to report the detected object to the control unit 70 within a certain amount of time, e.g. such that the control unit 70 has enough time to indicate to the one or more autonomous vehicles 30 that the road junction 100 is occupied. Another real-time condition may be that when an object is present in a monitored traffic zone, the set of sensors need to detect that the object is present in less than a predetermined time period. Each sensor in the set of sensors 50 may be mounted on infrastructure objects arranged in or around the road junction 100. The infrastructure objects may comprise lamp posts, traffic lights, posts purposed for mounting sensors, buildings, power lines, or any other suitable location wherein a sensor may have a view of the road junction 100. Since the sensors 50 are mounted on infrastructure, they are not subject to movement or vibrations, e.g. as they would be if mounted on vehicles, and therefore they may provide higher quality sensor data than sensors mounted, e.g. on vehicles.

FIGS. 2a-c illustrate example scenarios how traffic zones may be monitored by using several sensors 50 monitoring at least part of a particular traffic zone. The example scenarios illustrate that sensors may have different FOV and may monitor different areas. The different areas that are monitored by the set of sensors 50 may alone or collectively make up a traffic zone out of the plurality of traffic zones.

FIG. 2a illustrates an example scenario wherein two sensors 50 out of the set of sensors 50 are arranged each with approximately 180 degrees FOV angles for monitoring the first edge zone 10a. In the example scenario, some of the monitored area of the first edge zone 10a is monitored by both sensors. In the example scenario, some of the monitored area of the first edge zone 10a is monitored by only one sensor.

FIG. 2b illustrates an example scenario wherein three sensors 50 out of the set of sensors 50, wherein one sensor is arranged with approximately a 180 degrees FOV angle for monitoring the second edge zone 10b, and wherein two sensors are arranged with approximately a 120 degrees angle for monitoring the second edge zone 10b. In the example scenario, some of the monitored area of the second edge zone 10b is monitored by all or two sensors. In the example scenario, some of the monitored area of the second edge zone 10b is monitored by only one sensor.

FIG. 2c illustrates an example scenario wherein three sensors out of the set of sensors 50 are arranged each with approximately 45 degrees FOV angles for monitoring a third edge zone 10c, e.g. for use by the one or more secondary vehicles 40 for entering the central zone 20. In the example scenario, some of the monitored area of the third edge zone 10c is monitored by all or two sensors. In the example scenario, some of the monitored area of the third edge zone 10c is monitored by only one sensor.

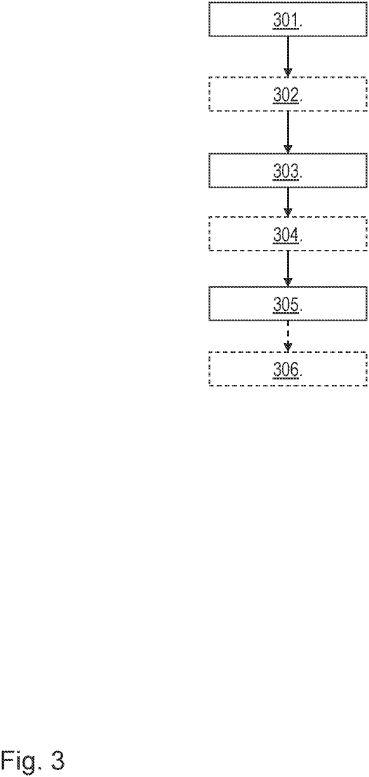

FIG. 3 shows example embodiments of a method for assisting the one or more autonomous vehicles 30 to drive in the road junction 100. The method comprises the actions described below, which actions may be taken in any suitable order unless mentioned otherwise. Optional actions are referred to as dashed boxes in FIG. 3.

In some embodiments, any one or more of below actions may be performed continuously or periodically, e.g. when new sensor data is needed for any action or embodiment explained below. Additionally or alternatively, any one or more of below actions may be performed based on some event triggering a need for sensor data of whether objects are present in any one or more traffic zones out of the plurality of traffic zones, e.g. light switches on traffic lights may trigger the need for new sensor data.

In some embodiments, since the method presented relates to improving safety for managing traffic, any one or more of the below actions 301-306 may involve one or more real-time conditions, e.g. performing the action within a predetermined period of time.

### Action 301

The method comprises obtaining sensor data from the set of sensors 50 arranged in the road junction 100 for monitoring the plurality of traffic zones. The sensor data is indicative of objects present in the plurality of traffic zones. The objects may typically be the secondary vehicles 40, however any object such as humans or animals may also be detected. In some embodiments, the sensors 50 may only be able to detect whether objects are present or not in a certain traffic zone out of the plurality of traffic zones. In these embodiments, the sensors are not able to detect any further details about what objects are present. In other words, the set of sensor 50 may not be able to distinguish which type of object is detected, and hence, all objects may be interpreted to be a secondary vehicle.

In these embodiments, the plurality of traffic zones comprises the central zone 20, and at least one edge zone 10a, 10b, 10c for use by the one or more secondary vehicles 40 for entering the central zone 20. For example, the at least one edge zone 10a, 10b, 10c may comprise all traffic zones which the one or more secondary vehicles 40 may use to enter the central zone 20. Additionally, in some embodiments, the monitored plurality of traffic zones may also comprise the additional edge zones 11a, 11b that are not intended for the secondary vehicles 40 to drive in. The additional edge zones 11a, 11b may be monitored for increased safety. The additional edge zones 11a, 11b may be monitored such that the one or more autonomous vehicles 30 may be triggered to perform an emergency stop in scenarios when the one or more secondary vehicles 40 enter any of the additional edge zones 11a, 11b. This is since when the one or more secondary vehicles 40 enters any of the additional edge zones 11a, 11b, this may indicate that the one or more secondary vehicles 40 have taken a wrong exit in the road junction 100.

### Action 302

The method may in some embodiments comprise obtaining, from a traffic coordinating unit 60, e.g. a traffic light arranged in the road junction 100, a traffic signal indicating whether the one or more autonomous vehicles 30, or the one or more secondary vehicles 40, are granted to enter the central zone 20. For example, the traffic coordinating unit 60 may dictate which of the one or more autonomous vehicles 30 and the one or more secondary vehicles 40 have a right of way.

### Action 303

The method further comprises, based on the obtained sensor data, determining whether there are any objects present in the plurality of traffic zones. As an example, the method may determine that some object is present in the first edge zone 10a, but there are no objects present in the central zone 20.

### Action 304

In some embodiment, the method may further comprise signalling to the one or more autonomous vehicles 30 that it is safe to enter the central zone 20. This signalling may occur in response to determining that no objects are present in the plurality of traffic zones. In other words, when the monitored zones of the road junction 100 is not occupied, the one or more autonomous vehicles 30 may start to drive as there is nothing in their way and there is no incoming traffic in the central zone 20.

In some embodiments, signalling to the one or more autonomous vehicles 30 that it is safe to enter the central zone 20 may also be performed in in response to that the obtained traffic signal indicates that the one or more autonomous vehicles 30 are granted to enter the central zone 20. Alternatively, the signalling only occurs when the autonomous vehicles 30 obtains a knowledge that they have a right of way in the road junction 100 by any other suitable means.

Furthermore, signalling to the one or more autonomous vehicles 30 that it is safe to enter the central zone 20 may comprise periodically transmitting one or more heartbeat signals to the one or more autonomous vehicles 30. The heartbeat signal may be any suitable periodic signal, which when present, indicates that no objects are present in the plurality of traffic zones.

Subsequently to signalling to the one or more autonomous vehicles 30 that it is safe to enter the central zone 20, it may be deduced by the method herein that the one or more autonomous vehicles 30 at least have started driving towards the central zone 20 and that there is a risk that any one or more of the one or more autonomous vehicles 30 are present in the central zone 20. In some embodiments, this may also comprise receiving signalling from the one or more autonomous vehicles 30 that they are or have started driving in the central zone 20.

### Action 305

In response to determining that at least one object is present in the at least one edge zone 10a, 10b, 10c, the method comprises indicating to the one or more autonomous vehicles 30 that the road junction 100 is occupied. In some embodiments, the indication may alternatively or additionally be that the road junction 100 is unsafe. This action may be performed subsequently to signalling to the one or more autonomous vehicles 30 that it is safe to enter the central zone 20.

Due to indicating that the road junction 100 is occupied and/or unsafe, the one or more autonomous vehicles 30 is informed that there may be incoming vehicles into the central zone 20. The one or more autonomous vehicles 30 may then have time to determine and take proper preventive action if needed. In some embodiments, the one or more autonomous vehicles 30 may be present in, or are approaching the central zone 20, and may perform an emergency stop. In some embodiments, the one or more autonomous vehicles 30 may determine that they have already left the central zone 20 or road junction 100. In these embodiments, preventive actions may not be necessary.

In some of these embodiments, determining that at least one object is present in the at least one edge zone 10a, 10b, 10c, may comprise obtaining new sensor data, different from the sensor data e.g. used for actions 303-304.

In some embodiments, indicating to the one or more autonomous vehicles 30 that the road junction 100 is occupied fulfils a real-time condition. This may involve that the indication may need to be interpreted by the one or more autonomous vehicles 30 in a minimum predetermined time period before the danger is present. For example, if the detected object is a vehicle, the one or more autonomous vehicles 30 may need a minimum predetermined time to take preventive action. Since this may be dependent on how close the one or more secondary vehicles 40 are, the size of the at least one edge zone, and how fast the one or more secondary vehicles 40 are travelling, fulfilling the real-time condition may involve arranging the size of the at least one edge zone 10a, 10b, 10c to be of large enough size such that the one or more secondary vehicles 40 is detected long before it reaches the central zone 20. For example, the size of the at least one edge zone 10a, 10b, 10c may be based on a time to traverse the size of the at least one edge zone 10a, 10b, 10c at maximum speed, e.g. such that there is enough time to indicated to the one or more autonomous vehicles 30 that there are incoming traffic and that an emergency stop may be needed.

In some embodiments, indicating to the one or more autonomous vehicles 30 that the road junction 100 is occupied comprises triggering the one or more autonomous vehicles 30 to perform an emergency stop. The method may also involve triggering the one or more autonomous vehicles 30 to perform any other suitable preventive action, e.g. any one or more out of: drive to a certain location, clear the central zone 20, change to a safety vehicle mode, reduce a maximum speed limit, activate an obstacle avoidance functionality. The triggered action may be chosen based on sensor data, e.g. obtained by the set of sensors 50.

In some embodiments, indicating to the one or more autonomous vehicles 30 that the road junction 100 is occupied comprises ceasing transmitting the one or more heartbeat signals to the one or more autonomous vehicles 30. When not receiving the one or more heartbeat signals, e.g. after some predetermined time, the one or more autonomous vehicles 30 may deduce that the road junction 100 is now occupied and/or unsafe. Alternatively, indicating to the one or more autonomous vehicles 30 that the road junction 100 is occupied comprises transmitting an alert signal to the one or more autonomous vehicles 30. The alert signal may in these embodiments indicate that the road junction 100 is occupied and/or unsafe.

### Action 306

The method may further comprise adapting the set of sensors 50 not to monitor the central zone 20. This may be performed in response to determining that no objects are present in the plurality of traffic zones. This may be performed since when it is known that no objects are present in the central zone 20, it is not needed to monitor the central zone 20 any further as we know that traffic from the one or more secondary vehicles 40 need to traverse the at least one edge zone 10a, 10b, 10c to reach the central zone 20, and hence, it is sufficient to monitor the at least one edge zone 10a, 10b, 10c.

In some embodiments, monitoring the central zone 20 is only performed by the set of sensors 50 when there is a switch between which of the one or more autonomous vehicles 30 and the one or more secondary vehicles 40 are granted to drive in the central zone, e.g. due to traffic light switches. This may be to ensure that the central zone 20 is clear of objects, e.g. as performed in action 304. Hence, the method may comprise adapting the set of sensors to monitor the central zone 20. This may be performed in scenarios when there is a switch between which of the one or more autonomous vehicles 30 and the one or more secondary vehicles 40 are to be granted to drive in the central zone.

In some embodiments, the set of sensors 50 are adapted iteratively based on a deduced or indicated switch of a right of way in the road junction 100, e.g. which of the one or more autonomous vehicles 30 and the one or more secondary vehicles 40 are granted to drive in the road junction 100.

In some embodiments, the method may comprise adapting the set of sensors 50 to not monitor the additional edge zones 11a, 11b, e.g. as it may be deduced that there should not be any traffic from these zones, or only traffic related to the one or more autonomous vehicles 30.

In embodiments wherein the set of sensors 50 have been adapted one or more times, the method may further comprise adapting the set of sensors 50 back to their original setting, e.g. to monitor the central zone 20 and the at least one edge zone 10a, 10b, 10c. This may be performed when the one or more autonomous vehicles 30 have left the road junction 100 or the central zone 20, e.g. which may be determined by receiving signalling from the one or more autonomous vehicles 30 and/or by detecting that the one or more autonomous vehicles 30 leaves a certain traffic zone, e.g. any one or more out of the one or more additional edge zones 11a, 11b. This may need to be performed before or latest when the one or more secondary vehicles 40 is handed the right of way, e.g. as indicated by the traffic coordinating unit 60.

In some embodiments, adapting the set of sensors 50, e.g. not to monitor the central zone 20, may comprise adjusting an active FOV of at least one sensor out of the set of sensors 50. In other words, at least one sensor out of the set of sensors 50 may be adapted to have a different sensing angle. In some embodiments, the adapted sensor may at least temporarily be repurposed to monitor a different traffic zone. Alternatively, in some embodiments, adapting the set of sensors may comprise deactivating at least one sensor out of the set of sensors 50. Deactivating a sensor may comprise turning the sensor off or configuring the sensor to be in an idle-mode. Alternative to deactivating a sensors, sensor data obtained from the sensor may be ignored.

Above actions and embodiments will now be exemplified by embodiments below. Any embodiment or action above or below may when suitable be combined in any suitable manner.

An example scenario of embodiments herein is relating to that the road junction 100 is an intersection as illustrated in FIG. 1. Embodiments herein may involve any action or feature as described with respect to Events 401-406 presented in Table 1 below. In this example scenario, the one or more secondary vehicles 40 are referred to as manually driven vehicles driving on a manual road.

Events below may relate to events occurring in the above described actions 301-306. The monitored zones below may relate to the central zone 20 and the at least one edge zone 10a, 10b. In this scenario only two edge zones are present, e.g. the first edge zone 10a and the second edge zone 10b as illustrated in FIG. 1, and hence the monitored edge zones is listed in below Table 1 as 10a, 10b. Every change in monitored zones in the

Table 1 below, may comprise an adaptation of the set of sensors, e.g. related to action 306 above. The actions performed listed in Table 1 below may relate to any action performed by embodiments herein, e.g. performed by the control unit 70 and/or performed by the one or more autonomous vehicles 30. The traffic light for the autonomous road and for the manual road may be right of way indications indicated by the traffic coordinating unit 60. With regards to below events in Table 1, when anything is detected in the monitored zones, an emergency stop may be triggered at the one or more autonomous vehicles 30.

TABLE 1

| | | | | |
|---|---|---|---|---|
| Event | Monitored zones | Action performed by autonomous vehicle | Traffic light autonomous road | Traffic light manual road |
| 401) Manual traffic has a right of way. | Optionally additional edge zones 11a, 11b. | Stop before intersection, e.g. before additional edge zones 11a, 11b and wait. | Red | Green |
| 402) Stop all traffic and wait until no objects are detected in the monitored zones. | Edge zones 10a, 10b and Central zone 20. Optionally additional edge zones 11a, 11b. | Stop before intersection, e.g. before additional edge zones 11a, 11b and wait. | Red | Red |
| 403) Give autonomous vehicle traffic right of way. | Edge zones 10a, 10b. | Drive through the intersection. Perform emergency stop if anything is detected in a monitored zone. | Green | Red |
| 404) Wait until the one or more autonomous vehicles 30 clear the intersection. | Edge zones 10a, 10b. | Drive through intersection. Perform emergency stop if anything is detected in a monitored zone. | Red | Red |
| 405) Prepare for manual right of way. Wait until no objects are detected in the monitored zones. | Central zone 20, edge zones 10a, 10b. Optionally additional edge zones 11a, 11b. | Stop before intersection, e.g. additional edge zones 11a, 11b, and wait. Perform emergency stop if anything is detected in a monitored zone. | Red | Red |
| 406) Restart with event 401) | | | | |

The safety argument behind the sequences of table 1 and/or actions 301-306 above, is that no manual actor should be able to enter the central zone 20 without entering the at least one edge zone 10a, 10b first. In event 401, the manual traffic has right of way. In event 402, it is ensured that no manual actor is in the intersection, e.g. the road junction 100, or about to enter it. This makes it safe for the one or more autonomous vehicles 30 to enter the central zone 20. As long as at least one autonomous vehicle out of the one or more autonomous vehicles 30 is in the intersection, e.g. the road junction 100, it may not be useful to monitor the central zone 20 as it e.g. would result in constant detection of objects. Instead, the at least one edge zone 10a, 10b, may be monitored to ensure that it is detected if any human actor is potentially entering the central zone 20. This may also have an added benefit to ensure that the one or more autonomous vehicles does not take the wrong exit in the intersection, e.g. which would then trigger an emergency stop.

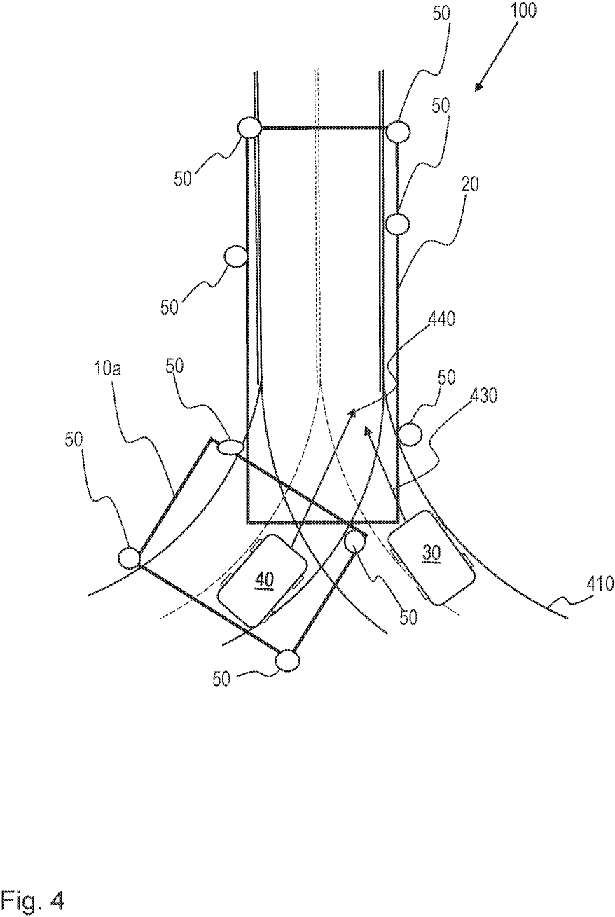

FIG. 4. illustrates an example of embodiments herein wherein the road junction 100 is a junction comprising a one-way road wherein there is one road provided for the one or more autonomous vehicles 30 to enter the central zone 20 in a direction 430, and one road provided for the one or more secondary vehicles 40 to enter the central zone 20 in a direction 440. In the example scenario, the one or more autonomous vehicles 30 may use a road 410 for entering the central zone 20. The road 410 may be associated with any of the one or more additional edge zones 11a, 11b (not shown). The central zone 20 is in this scenario on a one-way road. In this scenario, only the first edge zone 10a is provided as there is only one road for the one or more secondary vehicles 40 to enter the central zone 20. In this scenario the one or more autonomous vehicles 30 will ensure that there is no objects in the plurality of zones, in this case, the central zone 20 and the first edge zone 10a. When no objects are present, the one or more autonomous vehicles 30 may enter the central zone and may then monitor the first edge zone 10a for objects, e.g. indicating incoming traffic. In this scenario, the one-way road may eventually separate the traffic between the one or more autonomous vehicles 30 and the secondary vehicle 40 on different roads. However, even when the traffic is shared on one road after the central zone 20, the safety of managing traffic in the road junction 100 is still increased. This is since the traffic between the one or more secondary vehicles 40 and the one or more autonomous vehicles 30 is at least ensured to be separated at the most critical and unsafe part of the road junction 100, i.e. the merging point of two roads. After merging the two road, the remaining safety requirements on the one or more autonomous vehicles 30 will be reduced and thus efficiency and security of managing traffic is improved.

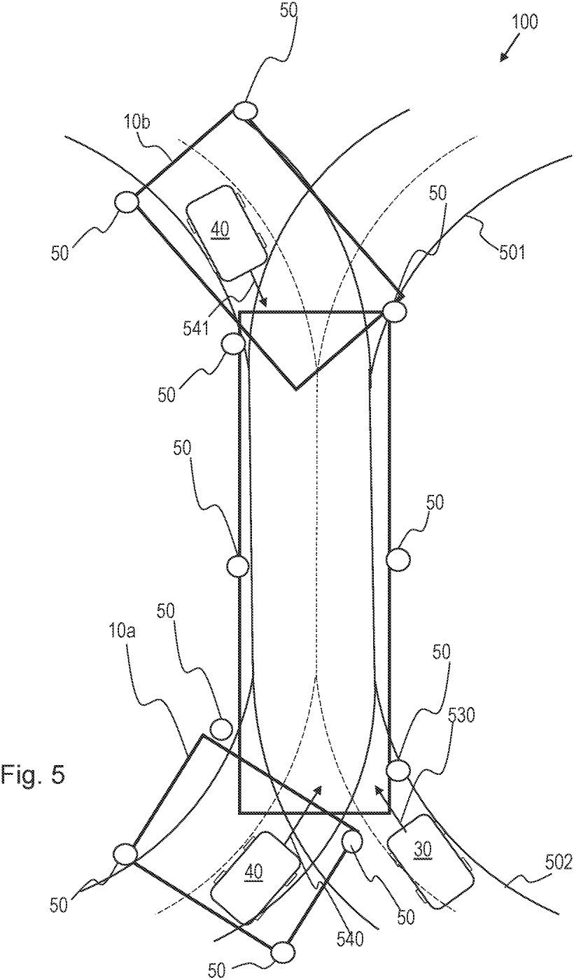

FIG. 5. illustrates an example of embodiments herein wherein the road junction 100 is a two-way junction wherein there are two roads 501, 502 for the one or more autonomous vehicles 30 to enter the central zone 20, e.g. from different directions such as direction 530, and two roads for the one or more secondary vehicles 40 to enter the central zone 20, e.g. from different directions 540, 541. In the example scenario, the one or more autonomous vehicles 30 may use any one or more out of roads 501, 502 for entering the central zone 20. These roads 501, 502 may be associated with the one or more additional edge zones 11a, 11b (not shown). The central zone 20 is in this scenario on a two-way road. In this scenario, the at least one edge zone 10a, 10b, comprises the first edge zone 10a illustrated at the bottom of the figure and the second edge zone 10b illustrated at the top of the figure.

Similar to the scenario in FIG. 1, the one or more autonomous vehicles 30 will first ensure that there are no objects present in the plurality of zones, in this case, the central zone 20, the first edge zone 10a, and the second edge zone 10b. When no objects are present, the one or more autonomous vehicles 30 may enter the central zone 20 and the set of sensors 50 may then monitor the first edge zone 10a, and the second edge zone 10b for objects, e.g. indicating incoming traffic.

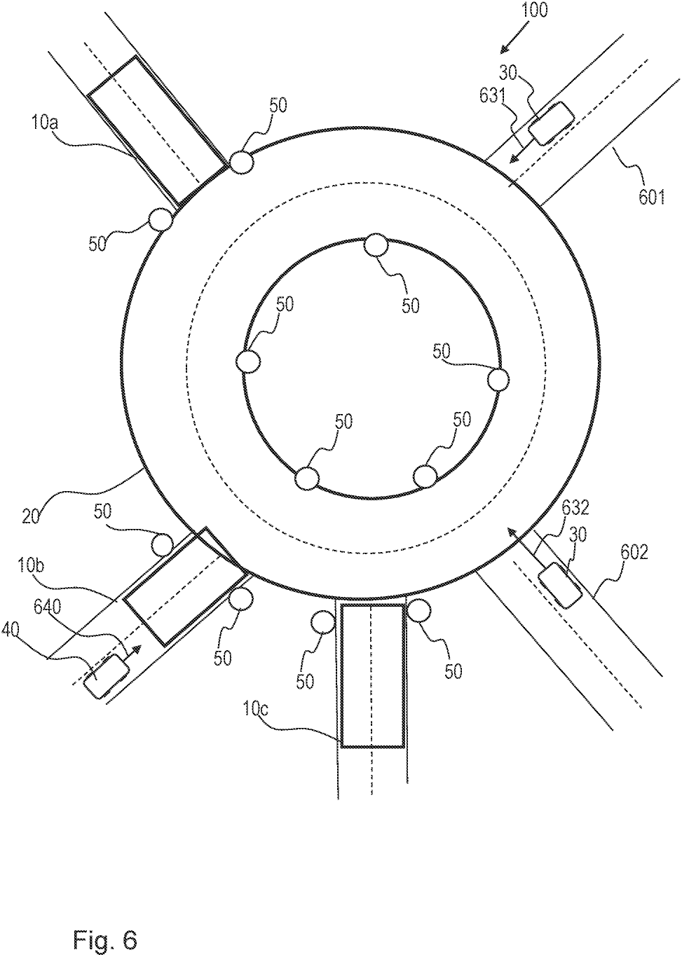

FIG. 6. illustrates an example of embodiments herein wherein the road junction 100 is a roundabout. In this scenario, the plurality of traffic zones, the at least one edge zone 10a, 10b, 10c, comprise more than two edge zones, including the third edge zone 10c.

In this scenario, the one or more secondary vehicles 40 drives in direction 640 and uses the at least one edge zone 10a, 10b, 10c for entering the central zone 20 i.e. comprising the first edge zone 10a, the second edge zone 10b, and the third edge zone 10c. In the example scenario, the one or more autonomous vehicles 30 may use any one or more out of roads 601, 602 for entering the central zone 20 driving in directions 641, 640. These roads 601, 602 may be associated with the one or more additional edge zones 11a, 11b (not shown). The central zone 20 may include an area of the inner part of the roundabout, e.g. which area may or may not comprise the middle-part of the roundabout, e.g. which middle-part is typically not used for vehicles to drive in. The one or more autonomous vehicles 30 will first ensure that there are no objects in the plurality of zones, in this case, the central zone 20, the first edge zone 10a, the second edge zone 10b, and the third edge zone 10c. When no objects are present, the one or more autonomous vehicles 30 may enter the central zone 20 and the set of sensors 50 may then monitor the first edge zone 10a, and the second edge zone 10b, and the third edge zone 10c, for objects, e.g. indicating incoming traffic.

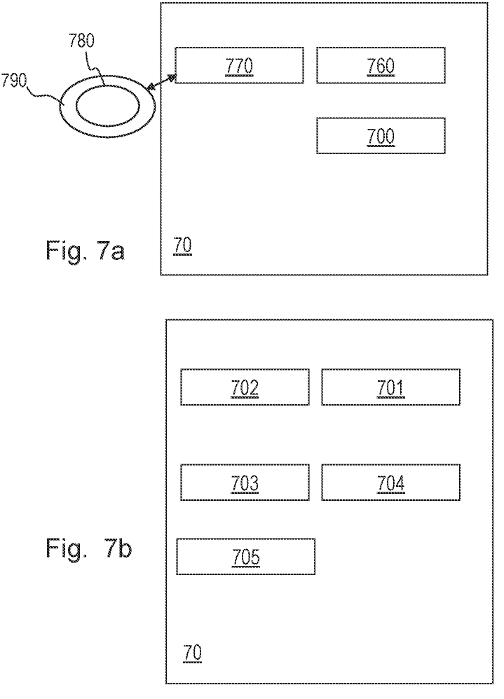

To perform the method actions described herein, e.g. any one or more out of the actions 301-306 above, the control unit 70 may be configured to perform any one or more of the above actions 301-306. The control unit 70 may for example comprise an arrangement depicted in FIGS. 7a and 7b.

The control unit 70 may comprise an input and output interface 700 configured to communicate with the entities of embodiments herein, such as e.g. with the one or more autonomous vehicles 30 and/or with the set of sensors 50. The input and output interface 700 may comprise a wireless and/or wired receiver (not shown) and a wireless and/or wired transmitter (not shown).

The control unit 70 may further be configured to, e.g. by means of an obtaining unit 701 in the control unit 70, obtain sensor data from a set of sensors 50 arranged in the road junction 100 for monitoring the plurality of traffic zones. The sensor data is indicative of objects present in the plurality of traffic zones.

The control unit 70 may further be configured to, e.g. by means of a determining unit 702 in the control unit 70, based on the obtained sensor data, determine whether there are any objects present in the plurality of traffic zones.

The control unit 70 may further be configured to, e.g. by means of a signaling unit 703 in the control unit 70, in response to determining that no objects are present in the plurality of traffic zones, signal to the one or more autonomous vehicles 30 that it is safe to enter the central zone 20.

The control unit 70 may further be configured to, e.g. by means of an indicating unit 704 in the control unit 70, in response to determining that at least one object is present in the at least one edge zone 10a, 10b, 10c, indicate to the one or more autonomous vehicles 30 that the road junction 100 is occupied. The control unit 70 may be configured to perform the indicating subsequently to signalling to the one or more autonomous vehicles 30 that it is safe to enter the central zone 20.

The control unit 70 may further be configured to, e.g. by means of an adapting unit 705 in the control unit 70, in response to determining that no objects are present in the plurality of traffic zones, adapt the set of sensors 50 not to monitor the central zone 20.

The control unit 70 may further be configured to, e.g. by means of the obtaining unit 701 in the control unit 70, obtain from a traffic coordinating unit 60, a traffic signal indicating whether the one or more autonomous vehicles 30, or the one or more secondary vehicles 40, are granted to enter the central zone 20.

The control unit 70 may further be configured to, e.g. by means of the signaling unit 703 in the control unit 70, signal to the one or more autonomous vehicles 30 that it is safe to enter the central zone 20 is further performed in response to the obtained traffic signal indicating that the one or more autonomous vehicles 30 are granted to enter the central zone 20.

The control unit 70 may further be configured to, e.g. by means of the signaling unit 703 in the control unit 70, signal to the one or more autonomous vehicles 30 that it is safe to enter the central zone 20 by periodically transmitting, e.g. by means of a transmitting unit 706 in the control unit 70, one or more heartbeat signals to the one or more autonomous vehicles 30.

The control unit 70 may further be configured to, e.g. by means of an indicating unit 704 in the control unit 70, indicate to the one or more autonomous vehicles 30 that the road junction 100 is occupied comprises ceasing transmitting the one or more heartbeat signals to the one or more autonomous vehicles 30.

The control unit 70 may further be configured to, e.g. by means of an indicating unit 704 in the control unit 70, indicate to the one or more autonomous vehicles 30 that the road junction 100 is occupied comprises transmitting, e.g. by means of the transmitting unit 706 in the control unit 70, an alert signal to the one or more autonomous vehicles 30, wherein the alert signal indicates that the road junction 100 is occupied.

The embodiments herein may be implemented through a respective processor or one or more processors, such as the processor 760 of a processing circuitry in the control unit 70 depicted in FIG. 7a, together with respective computer program code for performing the functions and actions of the embodiments herein. The program code mentioned above may also be provided as a computer program medium, for instance in the form of a data computer readable medium carrying computer program code for performing the embodiments herein when being loaded into the control unit 70. One such computer readable medium may be in the form of a memory stick. The computer program code may furthermore be provided as pure program code on a server and downloaded to the control unit 70.

The control unit 70 may further comprise a memory 770 comprising one or more memory units. The memory 770 comprises instructions executable by the processor in control unit 70. The memory 770 is arranged to be used to store e.g. information, indications, data, configurations, and applications to perform the methods herein when being executed in the control unit 70.

In some embodiments, a computer program 780 comprises instructions, which when executed by the respective at least one processor 760, cause the at least one processor of the control unit 70 to perform the actions 301-306 above.

In some embodiments, a respective computer readable medium 790 comprises the respective computer program 780, wherein the computer readable medium 790 is one of an electronic signal, an optical signal, an electromagnetic signal, a magnetic signal, an electric signal, a radio signal, a microwave signal, or a computer-readable storage medium.

Those skilled in the art will appreciate that the units in the control unit 70 described above may refer to a combination of analog and digital circuits, and/or one or more processors configured with software and/or firmware, e.g. stored in the control unit 70, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

1. A computer-implemented method for assisting one or more autonomous vehicles to drive in a road junction, wherein the road junction comprises a plurality of traffic zones, wherein the plurality of traffic zones comprise a central zone arranged for use by the one or more autonomous vehicles and one or more secondary vehicles, and wherein the plurality of traffic zones comprise at least one edge zone for use by the one or more secondary vehicles for entering the central zone, the method comprising:
- obtaining sensor data from a set of sensors arranged in the road junction for monitoring the plurality of traffic zones, wherein the sensor data is indicative of objects present in the plurality of traffic zones,
- based on the obtained sensor data, determining whether there are any objects present in the plurality of traffic zones,
- in response to determining that at least one object is present in the at least one edge zone, indicating to the one or more autonomous vehicles that the road junction is occupied.

2. The method according to claim 1, wherein the method further comprises:
- in response to determining that no objects are present in the plurality of traffic zones, adapting the set of sensors not to monitor the central zone.

3. The method according to claim 2, wherein adapting the set of sensors not to monitor the central zone comprises any or more out of:
- adjusting an active Field of View, FOV, of at least one sensor out of the set of sensors,
- deactivating at least one sensor out of the set of sensors.

4. The method according to claim 1, wherein indicating to the one or more autonomous vehicles that the road junction is occupied fulfils a real-time condition.

5. The method according to claim 1, wherein indicating to the one or more autonomous vehicles that the road junction is occupied comprises triggering the one or more autonomous vehicles to perform an emergency stop.

6. The method according to claim 1, wherein the method further comprises:
- in response to determining that no objects are present in the plurality of traffic zones, signalling to the one or more autonomous vehicles that it is safe to enter the central zone.

7. The method according to claim 6, wherein the method further comprises:
- obtaining, from a traffic coordinating unit, a traffic signal indicating whether the one or more autonomous vehicles, or the one or more secondary vehicles, are granted to enter the central zone, and
wherein signalling to the one or more autonomous vehicles that it is safe to enter the central zone is further performed in response to the obtained traffic signal indicating that the one or more autonomous vehicles are granted to enter the central zone.

8. The method according to claim 6, wherein signalling to the one or more autonomous vehicles that it is safe to enter the central zone comprises periodically transmitting one or more heartbeat signals to the one or more autonomous vehicles, and wherein indicating to the one or more autonomous vehicles that the road junction is occupied comprises ceasing transmitting the one or more heartbeat signals to the one or more autonomous vehicles.

9. The method according to claim 1, wherein indicating to the one or more autonomous vehicles that the road junction is occupied comprises transmitting an alert signal to the one or more autonomous vehicles, wherein the alert signal indicates that the road junction is occupied.

10. A control unit configured to perform the method according to claim 1.

11. A sensing arrangement for a road junction, wherein the sensing arrangement comprises the control unit according to claim 10, and a set of sensors arranged in the road junction for monitoring the plurality of traffic zones, the set of sensors being configured to detect objects present in the plurality of traffic zones and communicate sensor data indicative of detected objects to the control unit.

12. The sensing arrangement according to claim 11, wherein the set of sensors comprises one or more sensors with a configurable Field of View, FOV.

13. The sensing arrangement according to claim 11 wherein the set of sensors comprises one or more sensors with an object detection rate fulfilling a predetermined real-time condition.

14. A computer program comprising program code means for performing the steps of claim 1 when said program is run on a computer.

15. A computer readable medium carrying a computer program comprising program code for performing the steps of claim 1 when said program product is run on a computer.
